(19) United States
(12) Patent Application Publication
(10) Pub. No.: US 2001/0013009 A1
(43) Pub. Date: Aug. 9, 2001

(54) SYSTEM AND METHOD FOR COMPUTER-BASED MARKETING

(76) Inventors: DANIEL R. GREENING, SAN FRANCISCO, CA (US); JOHN B. HEY, CONCORD, MA (US)

Correspondence Address: FENWICK & WEST LLP, TWO PALO ALTO SQUARE, PALO ALTO, CA, 94306, US

(21) Appl. No.: 09/081,264

(22) Filed: May 19, 1998

Related U.S. Application Data
(60) Provisional application No. 60/047,220, filed on May 20, 1997.

(51) Int. Cl. G06F 17/60

(52) U.S. Cl. 705/10; 702/181

(57) ABSTRACT

A marketing system and method predicts the interest of a user in specific items—such as movies, books, commercial products, web pages, television programs, articles, push media, etc.—based on that user's behavioral or preferential similarities to other users, to objective archetypes formed by assembling items satisfying a search criterion, a market segment profile, a demographic profile or a psychographic profile, to composite archetypes formed by partitioning users into like-minded groups or clusters then merging the attributes of users in a group, or to a combination. The system uses subjective information from users and composite archetypes, and objective information from objective archetypes to form predictions, making the system highly efficient and allowing the system to accommodate “cold start” situations where the preferences of other people are not yet known.

### RELATED APPLICATION

This application claims the benefit of U.S. Provisional Application No. 60/047,220, filed May 20, 1997.

### BACKGROUND OF THE INVENTION

1. Field of the Invention

This invention relates in general to a system and method for marketing products and services, and in specific to a system and method for using a computer system to compare an individual's reaction to items to other people's reactions and to the assumed reactions of archetypes, thereby predicting the individual's reaction to items not yet sampled by the individual.

2. Description of Background Art

It is often helpful to predict the reactions of people to items they have not yet sampled. People have particular difficulty obtaining good recommendations for items that produce inherently subjective reactions. When evaluating an item that requires a substantial investment of time or money, people value good recommendations very highly. Examples of subjectively appreciated, high-involvement items include movies, books, music, games, food, groceries, special interest clubs, chat groups, online forums, web sites, and advertising.

The prevalence of movie critics, book reviewers, web page reviews and hyperlink indices, magazines evaluating products, and other appraising critics indicates a significant need for recommendations on subjectively appreciated items. However, the uniqueness of each item hinders objective comparison of the items relative to the response they will elicit from each person. Short synopses or reviews are of limited value because the actual satisfaction of a person depends on his reaction to the entire rendition of the item. For example, books or movies with very similar plots can differ widely in style, pace, mood, and countless other characteristics. Moreover, knowledge beforehand of the plot or content can lessen enjoyment of the item.

Public opinion polls attempt to discern the average or majority opinion on particular topics, particularly for current events. But, by their nature, the polls are not tailored to the subjective opinions of any one person. In other words, polls draw from a large amount of data but are not capable of responding to the subjective nature of a particular person.

Because people do not have the time to evaluate each purchase in objective detail, they rely on other indicators for quality: namely brand names, the recommendation of a trusted salesperson, or endorsement by a respected peer. However, often no such indicators exist. Even when they do exist, their reliability is often suspect.

Marketers frequently rely on surrogate indicators to predict the preferences of groups of people, such as demographic or psychographic analysis. Demographic analysis assumes that people living in a particular region or who share similar objective attributes, such as household income or age, will have the same taste in products. Psychographic analysis tries to predict preferences based on scoring psychological tests. However, because these surrogates are based on non-product related factors they perform poorly for individual tastes and needs, such as those of motorcycle riding grandmothers.

Weighted vector-based collaborative filtering techniques allow users to rate items stored in a database, then for each user assemble a list of like-minded peers based on similar ratings. A peer's rating vector is weighted more heavily when the peer has greater similarity to the user's. The ratings of the highest weighted peers are then used as predictors for the items a user has not rated. These predictions can then be sorted and presented as recommendations. Such systems are incapable of recommending items that no one has rated, and may consume much time or memory if they must compare a user to many users to get a sufficient number of predictions.

A second type of collaborative filtering technique computes the total number of exactly matching ratings two users have in common, and when this number exceeds a threshold the users are considered peers of each other. An item rated by a peer, but not by the user, has a prediction value equal to the peer's rating. This technique poses a trade-off: if the threshold is too high, the system may not be able to gather enough peers to make a prediction, and if the threshold is too low, the system may make predictions from peers not-very-similar to the user, making the predictions inaccurate.

A third type of collaborative filtering notes that there is often a relationship between items—a particular rating for one item may indicate a similar rating for another item. When a user rates one item, but not the other, the system uses that information to predict the rating for the other item. This technique works well when items can be easily categorize, however in these circumstances objective filtering techniques may work as well. When items are hard to categorize, this technique will provide inaccurate predictions or no predictions.

Accordingly, there is a need in the art for a method and system that recommends items that have not been rated. The method and system should make accurate predictions and handle items that are hard to categorize.

### SUMMARY OF THE INVENTION

The system and method according to a preferred embodiment of the present invention creates a personalized experience or a personalized set of recommendations for individuals based on their personal tastes. The system and method can make recommendations in a wide variety of products, media, services, and information, such as movies, books, retail products, food, groceries, web pages, television programs, articles, push media, advertisements, etc.

The system and method first records reactions which reflect a user's preference, interest, purchase behavior, psychographic profile, educational background, demographic profile, intellect, emotional qualities, or appreciation related to advertising, environment, media, purchase or rental items, etc. A user can create these reactions by interacting with a user survey or through any interface that records a user's behavior, such as how the user clicks on a banner advertisement, interacts with a game or quiz, scrolls through an article, turns a knob, purchases a product, etc.

The system and method retains reactions associated with raters. Raters include users, objective archetypes, and composite archetypes. Objective archetypes are hypothetical users created by an administrator, each hypothetical user's reactions to items being defined by how the administrator believes that hypothetical user will likely react. One such hypothetical user can be defined by uniform reaction to a criterion, such as “likes all books by Oliver Sacks.” Another such hypothetical user can be defined by using surrogate marketing data, such as “likes products thought to be appealing to women 19 to 25,” or “likes products thought to be appealing to Soccer Moms.”

Composite archetypes combine the ratings of other raters. One approach combines users with similar tastes by averaging their reactions to each item. The system allows a reaction to be recorded as a multidimensional value. This allows composite archetype reactions to be recorded as a mean and variance, or to include information indicating a confidence value in a mean reaction. The effect is similar to that of surrogate marketing data, in that a rater can include reactions to far more items than a single user might produce. However, the composite archetype is based directly on user reactions, and is not subject to the fallabilities of human interpretation.

After recording a user's reactions, the system and method then identifies mentors, or raters whose reactions are similar to those of the user. Each mentor is assigned a mentor weight, which indicates the similarity of the rater to the user. A prediction vector is computed by assembling a weighted average of individual mentor reactions. Entries in the prediction vector are predicted reactions of the user to individual items. Such entries can be sorted in order of best predicted reaction, and then provided to the user as recommendations.

By incorporating both subjective reactions from users and composite archetypes, and objective reactions from objective archetypes to form predictions, the system is highly efficient and accommodates “cold start” situations where the reactions of other users are not yet known.

In sum, the present invention provides a marketing system and method which:

uses the item preferences or item-related behaviors of a user to find other people with similar preferences, then uses those people to predict the user's response to new items; can produce a reasonably accurate predicted rating, even when no other person has rated an item; incorporates both subjective criteria (user preferences and behaviors) and objective criteria (attributes of items or market data) to make the best possible recommendation; performs collaborative filtering using the combined wisdom of groups of like-minded people; can use an existing database of items, classified by different characteristics; builds a database of “mentors” who have high affinity to specific users, which mentors can be used to infer various characteristics of the users; composes archetypes that represent bodies of thought, points of view, or sets of product preferences found in a group of people; and substitutes for demographic and psychographic characterizations of groups of people.

### BRIEF DESCRIPTIONS OF THE DRAWINGS

FIG. 1 is a flow diagram showing the logical architecture of a system and method for recommending items according to a preferred embodiment of the present invention.

FIG. 2 is a block diagram showing an architecture of a recommendation system implemented on a computer network according to an embodiment of the present invention.

FIG. 3 is an entity relationship diagram of four database tables according to an embodiment of the present invention.

FIG. 4 is a flowchart of steps in the user interface process according to an embodiment of the present invention.

FIG. 5 is a flowchart of steps in the mentor identification process according to an embodiment of the present invention.

FIG. 6 is a flowchart of steps in the objective archetype process according to an embodiment of the present invention.

FIG. 7 is a flowchart of steps in the composite archetype process according to an embodiment of the present invention.

FIG. 8 is a flowchart of steps in the build prediction vector subroutine according to an embodiment of the present invention.

FIG. 9 is a flowchart of steps in the compute similarity subroutine according to an embodiment of the present invention.

FIG. 10 is a flowchart of steps in the add to vector subroutine according to an embodiment of the present invention.

FIG. 11 shows the construction of several prediction vectors using only user rating information according to an embodiment of the present invention.

FIG. 12 shows the construction of several prediction vectors using a combination of user ratings and objective archetype ratings according to an embodiment of the present invention.

### DETAILED DESCRIPTION OF THE INVENTION

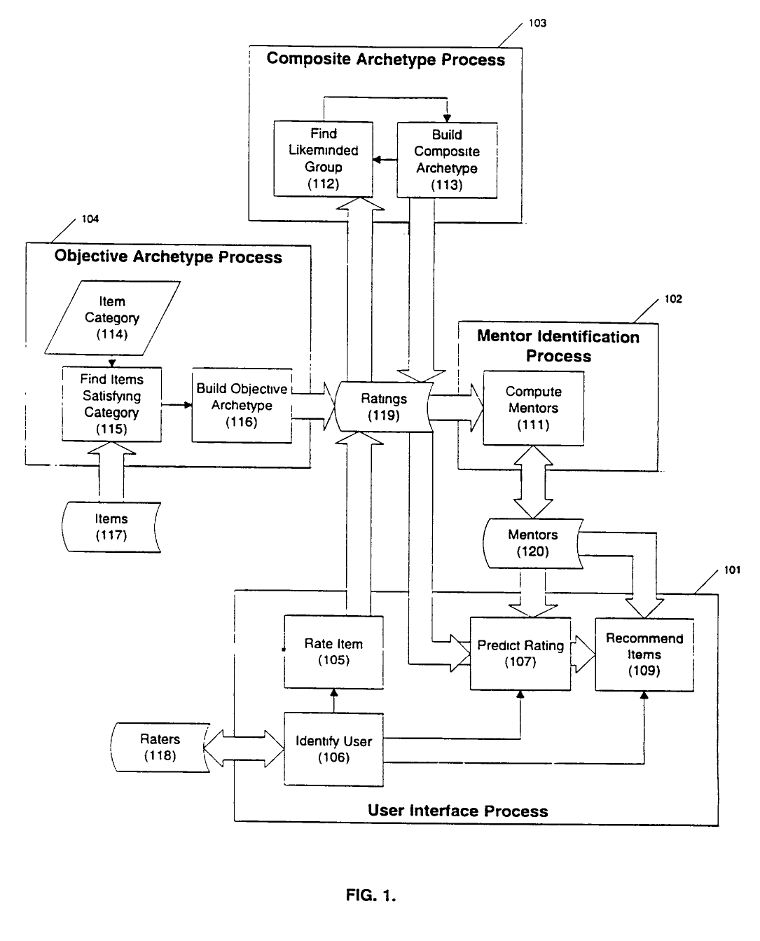

FIG. 1 is a flow diagram showing the overall architecture of a preferred embodiment of the marketing system and method. In FIG. 1, as well as the other figures, the blocks may be interpreted as physical structures or as method steps for performing the described functions. A user interface process 101 identifies a user, records reactions to items, predicts reactions to items, and recommends items. The user may be a person interacting with a touch-screen in a kiosk, a person interacting with a web-browser application, or a person interacting with a computer application. The user may want a personal recommendation for an item, such as a video tape or a music CD, or may want a personal experience, such as music or information that appeals to the user.

An objective archetype process 104 allows an administrator to assemble and store objective archetypes based on predicted reactions to items. Objective archetypes help solve the cold-start problem, where there are insufficient ratings on items to make a prediction.

A composite archetype process 103 creates new composite archetypes by finding like-minded people in a database and composing them. Composite archetypes help provide recommendations more efficiently. As mentors, composite archetype can often predict more reactions than other users, and are often more accurate than objective archetypes.

A mentor identification process 102 finds like-minded raters for each user, and stores the resulting associations in a database. Each mentor-user association includes a mentor weight, which reflects the accuracy and utility of the mentor as a predictor for the user.

The resulting system can predict the reaction of a user to items, based on either the reactions of other people or on objective characteristics of the items.

The user interface process 101 first identifies a user from among those registered in a rater table 118 by invoking an identify user step 106. A rate item step 105 tracks user behavior in the form of keyboard operations, mouse clicks, dial settings, purchases, or other user input to obtain a rating or behavioral sample for an item, and stores the user-item-rating triple in rating table 119.

The mentor identification process 102 successively compares the ratings of a user with a different rater, proposing the rater as the “mentor” or “like-minded peer” for the user. The compute mentors step 111 reads ratings from the rating table 119, compares the ratings of a user with those of a rater, assigns a similarity value, and stores the user-rater-similarity triple in a mentor table 120.

A user may request a predicted rating for an item, in which case the user interface process invokes a predict rating step 107. The predict rating step 107 obtains mentors from the mentor table 120 or a cache and then obtains each mentor's ratings to fill in a prediction vector.

A user may request a set of recommended items, in which case the user interface process invokes a recommend items step 109. The recommend items step fills in a prediction vector in the same manner as the predict rating step. The recommend items step 109 then sorts the items in order of best-rated-item first. The recommend items step 109 then recommends the best-rated-items to the user.

The objective archetype process 104 provides the ability for a system administrator to create and enter objective archetypes. For example, an archetypal user might like all music by Madonna, or all books written by Oliver Sacks. One way to specify an objective archetype is to input a search criterion. The objective archetype rates all items satisfying the criterion at the best rating.

One possible modification of the objective archetype process 104 is to input a rating for satisfying items rather than using the highest rating. Another possible modification of this process 104 is to input a mentor weight factor to be included in the archetype's rater table entry. An administrator can emphasize or degrade archetypes with certain types of criteria, which may have low correlation with user tastes, but in difficult circumstances could be used to predict the rating of an item.

Another possible modification of the objective archetype process 104 is to input specific item indices, along with specific ratings. This can be used to input predicted ratings based on other personalization technologies, such as demographics, psychographics, or the ratings of professional reviewers representing a particular viewpoint.

An item category reader 114 reads an item category from the system administrator and a find items satisfying category step 115 selects all items satisfying the item category from item table 117. A build objective archetype step 116 stores ratings in the rating table 119, which ratings indicate the objective archetype “loves” all the items found.

The system creates composite archetypes by combining ratings from multiple sources. If these sources are the ratings of users, the resulting composite represents the combined tastes of the group. There are two steps in the process: first, identifying like-minded raters for combination, and second, combining the raters.

The composite archetype process 103 successively finds user groups satisfying a criterion indicating like-mindedness using a find like-minded group step 112. The criterion can include demographic or psychographic information stored in the rater table 118, or can be based solely on similar ratings found in the rating table. Then a build composite archetype step 113 computes the ratings of the composite archetype from the ratings of the raters in the group, and stores the composite ratings in the rating table 119. This process is described in more detail below.

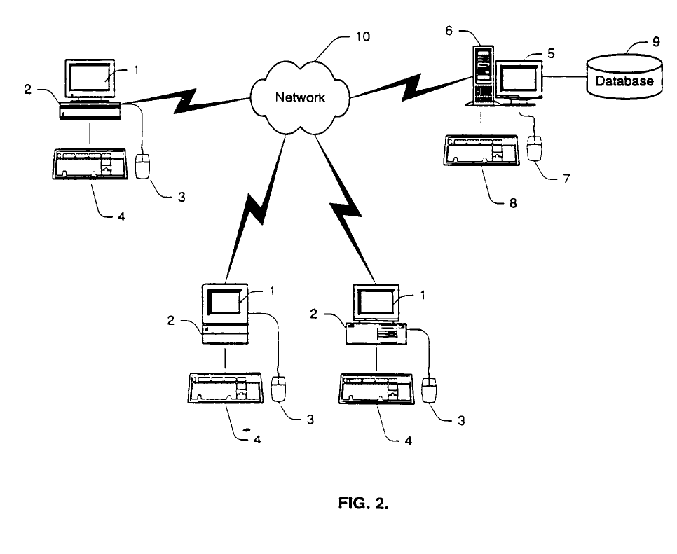

FIG. 2 is a block diagram showing the system architecture of an embodiment of the present invention. This embodiment would be suitable for web-based advertising, web-based movie or music recommendations, displaying push-media on client computers, and other client-server applications. A server computer 6, which contains one or more processors and one or more memory units, provides an interface to a system administrator, and stores information about raters and items. Client computers 2, each of which contains one or more processors and one or more memory units, allow users to interact with the system, entering reactions to items, obtaining predicted reactions, and getting recommendations or recommended media.

A database system 9 is hosted on the server computer 6 with a server display 5, a server keyboard 8, and a server mouse 7. The database system preferably retains the item table 117, rater table 118, rating table 119 and mentor table 120. As is well understood in the art, the marketing system described herein can be performed by hardware and/or software modules executing on the server computer 6. Server input devices 7 and 8 may be used to enter information about items, users and archetypes, and the server display 5 may be used to examine the different tables, including the various attributes of archetypes, users, items, mentors, and ratings.

The server computer 6 communicates with the client computers 2 via a network 10. Each client computer preferably has a client display 1, client keyboard 4, and client mouse 3. These specific forms of client input devices 3 and 4 and client display 1 are not required. Some client computers may have only input devices, some may have only displays, and some may use new input and output devices not shown here. Relevant aspects of the client devices are that a client computer 2 and its input devices can identify a user and record the reaction of the user toward a particular item or items, and a display can show a predicted rating, or a list of one or more recommended items.

The user's identity and reaction to items are transmitted via the network 10 to the server computer, which then records them via the user interface process. A request for a predicted rating or recommendation is transmitted via the network 10 to the server computer 6, which then obtains the result via the user interface process. The result is transmitted to the client computer via the network and displayed on the client display. The user interface process may run on the server or client computers, or partly on the server and partly on the clients.

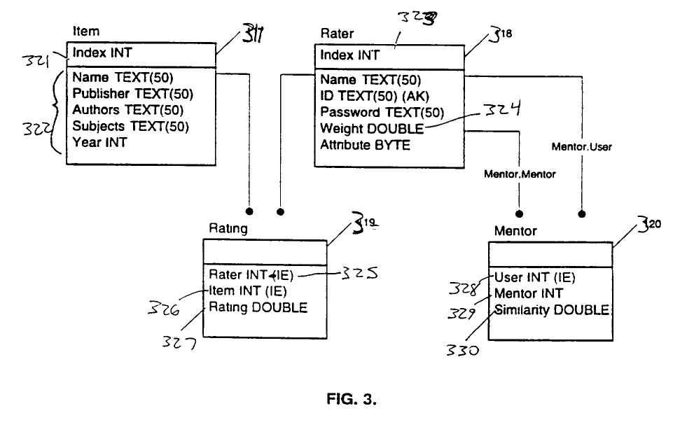

FIG. 3 is an entity-relationship diagram showing database tables in the system. An item table entry 317 in item table 117 contains a primary item index. Item table entries contain many fields particular to the specific attributes of the classes of items being stored in the item table. The example shown in FIG. 3 has attributes relevant to books, such as name, publisher, authors, subjects, and publication year 322.

A rater 318 in rater table 118 contains a primary user index 323. In addition, a double floating point number User.Weight 324 provides the ability to increase or decrease the relative similarity of the rater 318 when used as a mentor, which may be appropriate when the rater 318 refers to an archetype rather than a user.

A rating table entry 319 in rating table 119 contains a reference 325 to the rater table entry 323 who rated the item, and a reference 326 to the item table entry 317 being rated. Finally, the specific rating given to the item table entry is a floating point number Rating 327. For any item table entry 317 there may be zero or more rating entries 319. For any rater 318, there may be zero or more rating entries 319.

A mentor table entry 320 in mentor table 120 contains a reference 328 to the rater who is being mentored, and a reference 329 to the rater acting as a mentor. A precomputed double floating point number 330 contains the result of the compute similarity step.

A rater 318 may have several mentors, so the rater can be mentioned in zero or more mentor table entries 320. In a preferred embodiment, user entries which are archetypes need not have any mentors, so these user entries 328 would not appear in any mentor table entries 320.

A rater may act as mentor for several users, so the rater can be mentioned in zero or more mentor table entries 320.

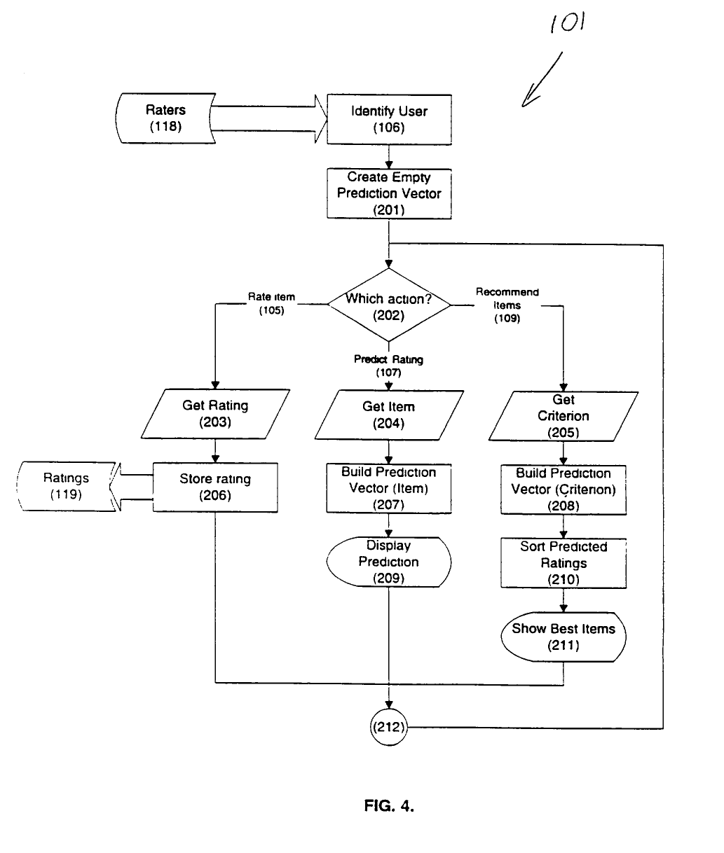

FIG. 4 is a flowchart showing of steps in the user interface process 101. This process identifies the user, records the user's behavior, allows the user to select from different services, and provides those services to the user.

First, an identify user step 106 uniquely identifies the user with a rater table entry in rater table 118. This can be performed, for example, by a user logging in with an id/password pair, by using a web browser cookie, by identifying a specific network address.

Next, a create empty prediction vector step 201 creates a data structure for storing predictions. Each vector element may be multidimensional, with at least one dimension having a special value indicating that the method has not set a prediction for this element. Other variables may contain the number of mentors contributing to the prediction, the sum of all the mentors' ratings, the sum of the squares of all the mentors' ratings, or any other function of the mentors' ratings, attributes of the mentors, the number of ratings, and the number of mentors.

Next, a which action decision 202 obtains information from the user or the state of the client computer 2 determining whether to perform a rate item step 105, a predict rating step 107, or a recommend items step 109.

If the decision 202 is the rate item step 105, the system next gets a rating using a get rating step 203. The get rating step 203 gets a rating by providing a scalar rating selection control from which the user selects from “Loved it” to “Hated it” which is recorded as 1 to 10. It can also get a rating by tracking or timing the user's behavior to infer or guess whether the user liked the item, for example by recording how many times a user saw an ad before clicking on it, or whether a user purchased an item when it was offered. It can also get a rating by recording the number of times a user mentioned a word in text chat, in a review, in a story, or in an article. It can also get a rating by recording the relative frequency that an article selected by the user mentions a keyword. Then a store rating step 206 stores the user-item-rating triple in the rating table 119.

If the decision 202 is the predict rating step 107, the system next gets a requested item using a get item step 204. The get item step 204 gets a criterion by the user selecting the item from a menu or entering the name of the item in a search field, then finding the unique item satisfying the criterion. Another embodiment allows a broader criterion, and the method then obtains successive predictions for each item satisfying the criterion.

Next, a build prediction vector(item) step 207 calls the build prediction vector subroutine with a search criterion that predicted items must satisfy. The build prediction vector subroutine fills in the prediction vector and returns.

Next, a display prediction step 209 examines the prediction vector for the element corresponding to the item. If the element has been set, the display prediction step 209 computes the prediction from the multidimensional element and displays it. The to display prediction step 209 may show the predicted rating, the prediction confidence, the number of mentors contributing to the prediction, the variance of the mentors' ratings, scaling information about the mentors ratings, or any other functions of the multidimensional element.

If the decision 202 is the recommend items step 109, the system next gets a criterion using a get criterion step 205. The criterion can include item attributes (such as author name, musician, genre, publication year, etc.), overall rating properties (such as popularity, controversy, number who have rated it, etc.), or user-specific information (such as predicted rating, confidence in the prediction, prediction variance among mentors, number of mentors who have rated the item, etc.). Next, a build prediction vector(criterion) step 208 calls the build prediction vector subroutine with the criterion obtained in the get criterion step 205. The build prediction vector subroutine 208 fills in the prediction vector and returns.

Next, a sort predicted ratings step 210 finds prediction vector elements satisfying the criterion, and sorts those elements by predicted rating, by confidence, by some other attribute of the vector's multidimensional entries, or by a functional combination of the attributes in each element. The sort predicted ratings step 210 can use any commonly known sorting mechanism such as bubble sort, quick sort, heap sort, etc.; or maintain a sorted index to the vector elements, such as with a binary tree, B-tree, ordered list, etc. If the vector element attributes contain precedence information, the sort predicted ratings step can sort elements in topological order. The ordering of the items need not be best first, but can also be worst first.

Next, a show best items step 211 produces the top listed elements by displaying on a screen, printing out a list, storing the results in a database, transmitting the results, or by some other method.

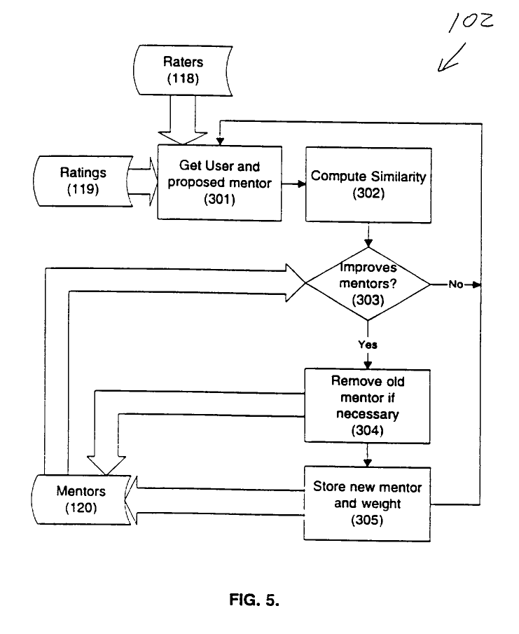

FIG. 5 is a flowchart of steps in the mentor identification process 102. For each user in the system, this process 102 finds raters, assigns a similarity weight, then decides whether to include the rater in the user's list of mentors.

First, a get user and proposed mentor step 301 chooses a user and a proposed mentor from the rater table 118. This can be accomplished by randomly selecting both, by selecting a user at random and selecting a proposed mentor from a list of potential mentors (such as all user entries that have rated at least 2 items in common with the user), by selecting a user and proposed mentor from a limited segment, by a combination of these methods, or by other methods.

One embodiment of the identify mentors process predicts ratings and recommends items based solely on mentors selected from objective archetypes, composite archetypes, or both, without including other users as potential mentors. This choice may improve performance when there is a limited amount of storage available. One variation of this embodiment favors mentors selected from archetypes, but also includes users. Another variation favors mentors who can predict the user's response to more items, which would favor users who have rated a large number of items and favor composite archetypes.

Next, a compute similarity step 302 computes a scalar function of the ratings in the user and proposed mentor. Next, an improves mentors decision 303 determines whether the maximum number of mentors has been reached for the user or if the proposed mentor has better similarity than the lowest similarity mentor table entry for this user. If no, the system loops back to the get user and proposed mentor step 301 and starts again.

If yes, the system next performs a remove old mentor if necessary step 304, which eliminates the lowest similarity mentor table entry for this user if the maximum number of mentors per user has been reached.

Next, the system performs a store new mentor and weight step 305, which creates a user-mentor-similarity triple using the proposed mentor in the mentor field, and stores it in the mentor table 120. Next, the method loops back to the get user and proposed mentor step 301 and starts again. A preferred embodiment runs this loop in a background process, constantly attempting to improve each user's mentors. In addition, the mentor identification process 102 can be performed in parallel by multiple machines. In this embodiment, a master task randomly segments the users among different processors, then starts the mentor identification process on each processor. Each mentor identification process then randomly chooses users within its segment, evaluates their similarity, and stores new mentors. When a certain number of user-mentor pairs have been evaluated, each mentor identification process stops. When all mentor identification processes stop, the master task resumes operation and creates a different random segmentation of the users, and begins again. The advantage of this approach is that it limits the amount of locking or atomic actions required to process mentors, improving performance over other types of parallel processing.

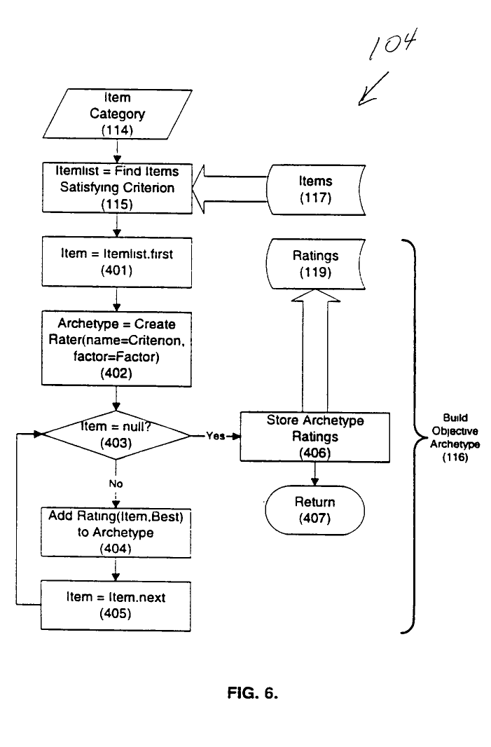

FIG. 6 is a flowchart showing steps in the objective archetype process 104. This process allows an administrator to enter criteria associated with archetypes, finds items satisfying the criteria, assemble an archetype, and stores the result. This process also allows an administrator to enter specific item ratings for a hypothetical user based on marketing information, demographic profiles or psychographic profiles.

First, an item category reader 114 inputs the item category for the archetype. Next, a find items satisfying criterion step 115 finds items 117 satisfying the criterion using any of several commonly known methods, such as a database select operation, and assembles them into a list (which can be stored by using a linked list, an array, or any other ordered data structure).

Next, a item=itemlist.first step 401 selects the first entry in the list. Then, a create objective archetype user step 402 creates a rater table entry 318 marked with attributes indicating the criterion and a weighting factor. Next, an item=null decision 403 determines whether the items satisfying the criterion have been exhausted. If so, the system next performs a store archetype ratings step 406, which stores all the ratings that have been assembled in a temporary rating list for this archetype in the rating table 119.

If no, an add rating step 404 adds a new rating for the item to the temporary rating list. This rating is a user-rating-item triple, where the rating field is set to the highest possible rating (i.e., the numeric equivalent of “loved it”). Next, the system performs a item=item.next step 405, which gets the next item satisfying the criterion, and then loops back to the item=null decision 403.

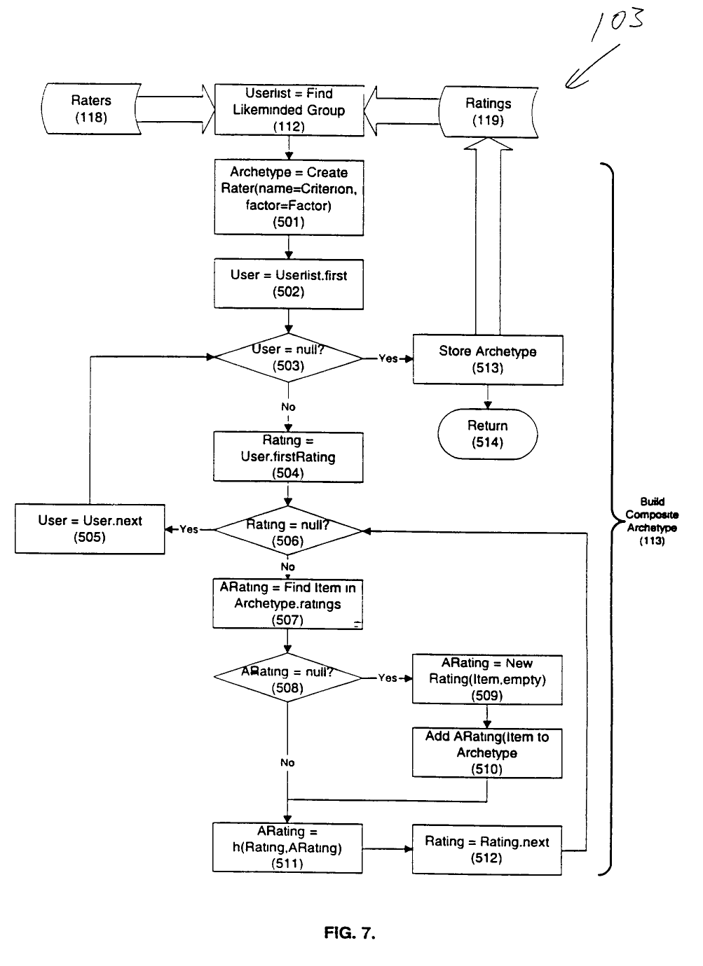

FIG. 7 is a flowchart showing of steps in the composite archetype process 103. This process finds groups of like-minded raters, merges them into a single rater, and stores the result. First, a find like-minded group step 112 finds user groups satisfying a criterion indicating like-mindedness. The criterion can be based on demographic or psychographic information stored in the rater table 118, or on users clustering around similar ratings found in the rating table 119.

One embodiment for finding like-minded groups views the situation as a partitioning problem over all the users, which problem is to optimize the overall like-mindedness of each partition. Each partition then becomes a like-minded group for the find like-minded group step 112.

This embodiment includes a cost function that measures the cost of a partitioning, and a permutation operation that permutes the partitioning. The algorithm can then be any of several combinatorial optimization algorithms. A preferred embodiment uses an algorithm called simulated annealing.

The Like-Minded Partitioning problem is this: given a set of users U and a number p, find a partitioning P of U with users evenly distributed among p partitions, such that a cost function c(P) is minimized. The following paragraphs define cost function c(P).

Let I be the set of m items in the item table 117 I={1, . . . , m}. Let U be the set of n users in the raters table 118, U={1, . . . , n}. Let r(u,i) be an item rating function for each user u and item i, so that r(u,i)<0 indicates user u has not rated item i, and r(u,i) ∈[0,1] indicates the user's rating for item i, with 0 the worst rating, and 1 the best. Let U(i) be the set of users in set U who have rated item i.

Let U′⊂U be an arbitrary subset of U. Let R(U′,i)={<u,i,r>|r ∈[0,1] is the rating user u∈U′ gave to item i}. Let

$$R ( {U}^{′} , {I}^{′} ) = {⋃}_{i ∈ {I}^{′}} R ( {U}^{′} , i ) .$$

Let I(U′)={i∈I|R(U′,i)≠{ } }.

Let \overline{r}(U′,i) represent the average rating for item i among those users in U′ who have rated it, with \overline{r}(U′,i) undefined when no user in U′ has rated item i. Let σ²[\overline{r}(U′,i)] represent the variance of ratings for item i among those users in U′ who have rated i, with σ²[\overline{r}(U′,i)] undefined when no user in U′ has rated item i.

Define the disagreement cost of a set of users U′ as

$$d ( {U}^{′} ) = {\sum }_{i ∈ I ( {U}^{′} )} \vert U ( i ) \vert \cdot {σ}^{2} [ r ( {U}^{′} , i ) ]$$

Define the missing background cost of a set of users U′ as

$$b ( {U}^{′} ) = {( \vert {U}^{′} \vert - \frac{\vert R ( I ) \vert}{\vert I ( {U}^{′} ) \vert} )}^{2} .$$

Let f(U)=d(U)+b(U) be the “incoherence cost” of group U.

Given a partitioning P={P₁, . . . , Pₖ} of U, define cost function

$$c ( P ) = {\sum }_{i = 1}^{k} f ( {P}_{i} ) .$$

The simulated annealing embodiment inputs the number of partitions (k) to create, an initial temperature T and the temperature adjustment a∈(0,1) from a system administrator. It creates k partitions and randomly and evenly assigns users to each partition. This is the initial partitioning P. The simulated annealing embodiment computes the cost of this partitioning E=c(P) as defined above.

The embodiment randomly chooses two users from different partitions, swaps them to create a new partitioning P′, and then computes E′=c(P′). Δ=E′−E. If Δ is negative, it accepts the new partitioning P′. If Δ is positive, it accepts the new partitioning P′ with probability e^{-Δ/T}.

The embodiment reduces the temperature so T=aT, and proceeds through the loop again until the cost does not change over 100 iterations, at which point it is finished.

Improvements to this basic simulated annealing algorithm are well-documented in computer science, physics, and mathematics literature. Other embodiments of the method may include these improvements. In particular, improving the method by automatically setting the initial temperature, adaptive methods for modifying the temperature over time, adaptive methods for permuting the partitioning that would replace swapping random users, fast methods for computing the exponential function, and a more sophisticated method for determining when to stop are possible embodiments of this invention.

Each partition in partitioning P so obtained is then successively fed into a create composite archetype user step 501. The create composite archetype user step 501 creates a rater table entry marked with an attribute indicating a weighting factor. Next, a user=userlist.first step 502 sets the current user to the first user in the like-minded group. Next, a user=null decision 503 determines whether the users in the group have been exhausted.

If yes, a store archetype step 513 stores all the ratings that have been assembled in a temporary rating list for this archetype in the rating table 119. It may also adjust a weighting factor for the archetype. It also stores a rater table entry for the archetype in the rater table. If no, a rating=user.firstrating step 504 sets the current rating to the first rating in a list of all the rating entries associated with the user stored in the rating table.

Next, a rating=null decision 506 determines whether the ratings have been exhausted for the user. If yes, a user=user.next step 505 sets the current user to the next user in the list and loops back to the user=null decision 503.

If no, a find item in archetype step 507 obtains the entry associated with this item in the temporary rating list. Next, an arating=null decision 508 determines whether the entry was missing. If yes, a new rating step 509 creates a new rating triple, and an add arating step 510 adds the entry to the temporary rating list.

Next, an arating=h(rating,arating) step 511 computes new values for the attributes of the current archetype rating table entry by performing function h on fields in the user rating table entry and the archetype rating table entry.

One embodiment of the arating=h(rating,arating) step merely averages the rating into the arating table entry by defining the archetype's rating to have three dimensions: a count of the number of users contributing to the rating, a sum of all the ratings from contributing users, and the average of the ratings. Next, a rating=rating.next step 512 moves to the user's next rating and loops back to the rating=null decision 506.

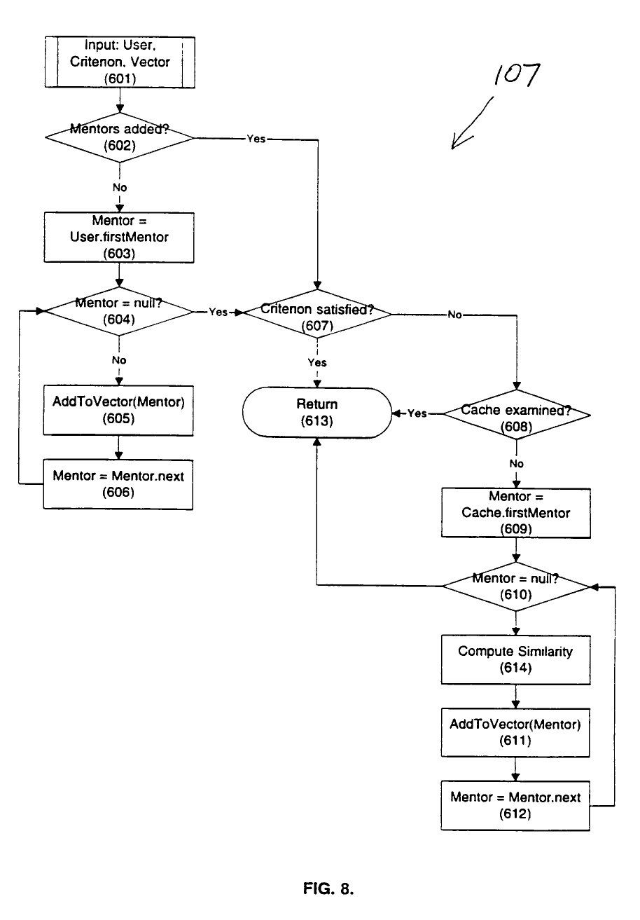

FIG. 8 is a flowchart showing steps in the build prediction vector subroutine illustrated in FIG. 4, which is generally shown as the Predict Rating process 107 of FIG. 1. This subroutine finds mentors associated with a user, and, for each mentor, adds its contribution to a prediction vector. The prediction vector predicts the user's reaction to items. One embodiment of the system creates a prediction vector at the time a prediction or a recommendation is required. This allows the system to store only the mentors and their weights, saving significant storage over computing the prediction vector at the time of producing the weight.

Constructing the prediction vector can take several forms. In a simple embodiment, the prediction vector contains a single scalar for every item. The system sorts the mentors in order of their similarity, with greatest similarity first, then for each mentor finds those items rated by the mentor but not by the user or by previous mentors, and stores the mentor's rating in the vector element associated with those items. Special scalars outside the rating range indicate that the item has not yet been rated or predicted, and that the user rated the item.

More complex embodiments include averaging the mentors' ratings for an item, computing a weighted average of ratings for each item, or storing a confidence level or standard deviation with each prediction. The method shown in the flowchart of FIG. 8 provides opportunities to use sophisticated statistical techniques and store intermediate values in both the rating table entries and the elements in the prediction vector.

First, an entry step 601 accepts the user, criterion and vector input parameters. The criterion parameter provides information about the attributes of the desired predictions in the vector, such as within a particular genre, written by a particular author, has an average rating higher than some number, or has a high confidence.

Next, a mentors added decision 602 determines whether the mentors for this user have already been added to the vector, and stores this determination as an attribute of the vector. If yes, a criterion satisfied decision 607 is made.

If the mentor added decision 602 is no, a mentor=user.firstmentor step 603 sets the current mentor to the first of all mentors in those naming this user in the mentor.user field. Next, a mentor=null decision 604 determines whether all of the user's mentors have been exhausted. If yes, the criterion satisfied decision 607 is made.

If no, an addtovector(mentor) step 605 adds all the ratings made by the mentor to the prediction vector. Next, a mentor=mentor.next step 606 sets the current mentor to the next in the list, and then loops back to the mentor=null step 604.

The criterion satisfied decision 607 determines whether the input criterion is satisfied. If yes, the subroutine returns 613. If no, a cache examined decision 608 determines whether a local cache of recently used mentors has been examined.

If no, a mentor=cache.firstmentor step 609, a second mentor=null step 610, a compute similarity step 614, a second addtovector(mentor) step 611, and a second mentor=mentor.next step 612 process the entries in the cache as if they were mentors to the user. The intent of these steps is to try to satisfy the criterion with items predicted by cached user ratings, when the items predicted by mentors in the mentor table 120 could not satisfy the criterion.

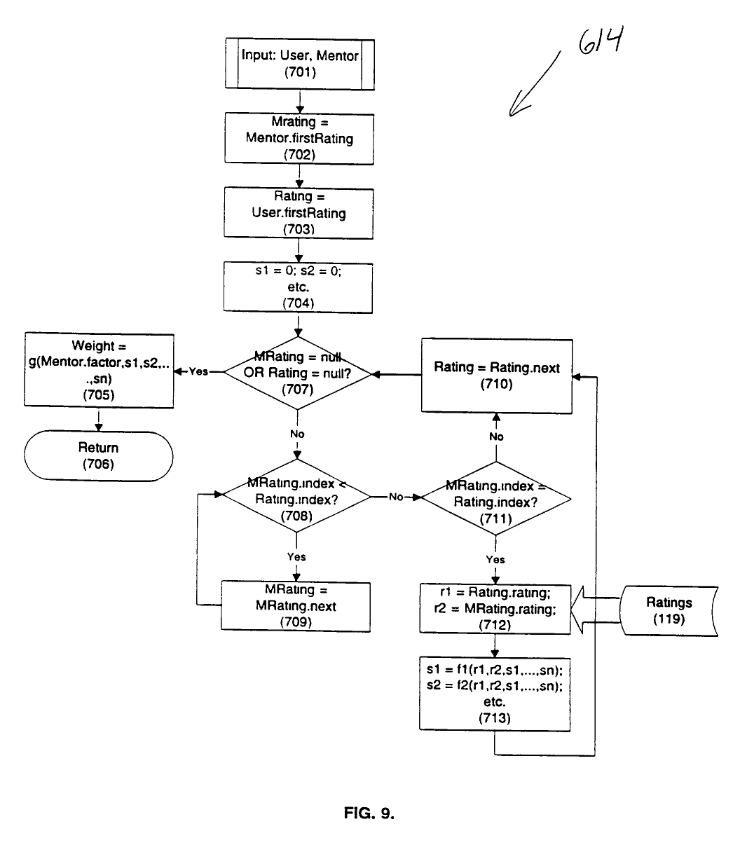

FIG. 9 is a flowchart showing steps in the compute similarity subroutine 614. This subroutine compares a user to a mentor and returns a similarity value indicating how valuable the mentor is as a predictor for the user's reaction to items. The computation of mentor similarity can be done in several ways, but is generally a function of attributes of the user, of the proposed mentor, of the user's ratings, and of the proposed mentor's ratings.

For example, one embodiment has users rating item from 1 (hated it) to 13 (loved it) and uses a mentor similarity function defined such that similarity

$$( u , m ) = \frac{2 \vert X \vert - 1}{{\vert X \vert}^{2}} {\sum }_{i ∈ X} f ( r ( u , i ) - r ( m , i ) ) ,$$

where I(u) is the set of items rated by u, where r(u,i) is the user u's rating of item i, where X=I(u)∩I(m) is the set of items rated by users u and m, and where f(x) is defined in Table I:

TABLE I

| x | ƒ (x) |
|---|---|
| 0 | 10 |
| 1 | 9 |
| 2 | 6 |
| 3 | 4 |
| 4 | 2 |
| 5 | 1 |
| 6 | 0 |
| 7 | 0 |
| 8 | −1 |
| 9 | −6 |
| 10 | −8 |
| 11 | −10 |
| 12 | −10 |

First, an entry step 701 accepts a user and mentor as input parameters. The mentor is a proposed mentor for the user. An mrating=mentor.firstrating step 702 sets the current mrating to the first rating in the mentor's ratings list. For purposes of this subroutine, the mentor's ratings list and the user's ratings list are presumed to be ordered in ascending order based on the ratings.item.index field.

Next, a rating=user.firstrating step 703 sets the current rating to the first rating in the user's ratings list. Next, an initialize variables step 704 sets one or more local variables to their initial values. These initial values may be partly determined by information stored in the rater table entries associated with the user and the mentor.

Next, an ratings exhausted decision 707 determines whether either the mentor's ratings list or the user's ratings list have been exhausted. If yes, a weight computation step 705 computes the similarity as a function of a factor associated with the mentor and the local variables, and then returns 706.

If no, an mrating.index<rating.index decision 708, a mrating=mrating.next step 709, and a mrating.index=rating.index decision 711 together find the next occurrence of two ratings for the same item in the user's ratings list and the mentor's ratings list.

After the method finds two ratings for the same item, an r1 r2 setting step 712 obtains the rating table entries 319 from the rating table 119. Next, an intermediate computation step 713 computes functions of the two ratings and the local variables, and stores them in the local variables. The system then loops back to a rating=rating.next step 710 to start getting the next set of matching rating pairs.

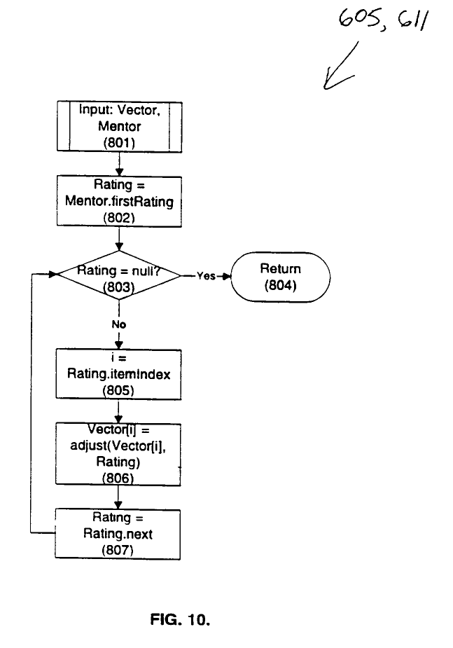

FIG. 10 is a flowchart showing of steps in the add to vector subroutine illustrated generally by processes 605 and 611 in FIG. 8. This subroutine modifies a prediction vector based on the ratings of a mentor and the previous contents of the prediction vector.

First, an entry step 801 accepts the vector and mentor input parameters. Vector is the prediction vector to be filled in. Mentor is the user whose ratings are used to fill in the vector. Next, a rating=mentor.firstrating step 802 sets the current rating to the first rating in the mentor's list. Then, a rating=null decision 803 determines whether the mentor's ratings have been exhausted. If yes, the subroutine returns 804.

If no, an index setting step 805 sets the current index i to the rating's unique index. Next, an adjustment step 806 adjusts the prediction vector's entry associated with item i to the value of a function adjust of the vector element and the rating. Next, a rating=rating.next step 807 sets the current rating to the next in the user's rating list and loops back to the rating=null decision 803.

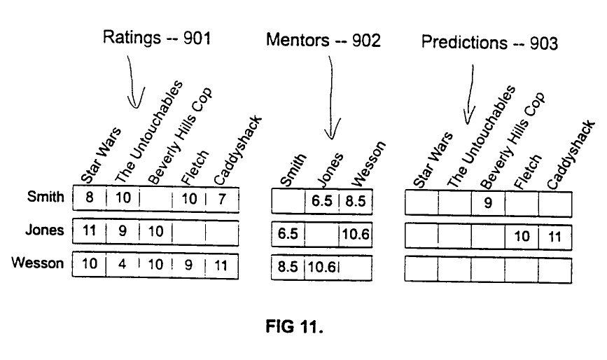

FIG. 11 shows the construction of several prediction vectors using only user rating information. First, a rating table 901 shows three users, Smith, Jones, and Wesson. The ratings are on a 1 to 13 scale, with 1 being the lowest rating “hated it” and 13 being the highest rating “loved it.” Smith has rated four movies: Star Wars, The Untouchables, Fletch and Caddyshack. Jones has rated three movies: Star Wars, The Untouchables, and Beverly Hills Cop. Wesson has rated all the movies.

Next, a mentor table 902 shows the result of allowing the mentor identification step 102 to associate each user with each other user as a mentor. Then, a prediction vector table 903 shows the result of creating the prediction for each user. The function h used in step 511 in this case does not store predictions for items already rated by the user. Since Wesson has rated all the items, no predictions are provided for Wesson. For Smith the system computed a prediction element for Beverly Hills Cop of 9 (“mostly liked it”). For Jones, the system computed predictions for Fletch of 10 (“liked it”) and Caddyshack of 11 (“really liked it”).

FIG. 12 shows the construction of several prediction vectors using a combination of user ratings and objective archetype ratings. A set of books 920 is rated by five different objective archetypes 922 and by three different users 923. The system finds a set of mentors 921 for each real user. Note that the mentor similarity weights in this case are adjusted by weights provided in the objective archetype rater table entries. The prediction vector is constructed from the mentor list in the manner described in FIG. 11. Recommending items is a simple matter of identifying items and predictions which satisfy a criterion, then sorting them in terms of a function of the multidimensional element in the prediction vector. A simple embodiment simply sorts the elements by the predicted rating. Another embodiment uses a combination of the predicted rating and the confidence.

This archetype recommendation system provides the ability to predict a user's response to new items, based on similar users' tastes in combination with objective information about the items, and thereby recommend new items to a user efficiently and accurately.

While the description above contains many specifics, these should not be construed as limitations on the scope of the invention, but rather as examples of preferred embodiments. Many other variations are possible. For example, a web advertising server could track a user's click through behavior, then use that information to rate the ads. Advertisements featuring the same class of product, designed by the same studio, referring to products by the same company, or targeting the same audience can be categorized by objective archetypes. Groups of people responding to the same compliment of ads can be composed together in a composite archetype.

For another example, the relationships between users and objective archetypes can be used to create a psychographic profile of those users, relative to a set of items.

Accordingly, the scope of the invention should be determined not by the embodiments illustrated, but by the appended claims and their legal equivalents.

What is claimed is:

1. A method for predicting the reaction of a selected user in a group of users to an item not rated by the selected user in a set of items including items previously rated by the selected user, the method comprising the steps of:
defining, for each user in the group, and for each item in the set of items sampled by that user, a rating representing the reaction of the user to the item;
defining a plurality of objective archetypes, each representing a hypothetical user and associated with at least one item in the set;
defining, for each of the plurality of objective archetypes, a rating representing the hypothesized reaction of the represented hypothetical user to the associated at least one item;
selecting a set of mentors from the users in the group and from the plurality of objective archetypes based on the similarity of the ratings of each user in the group and each objective archetype to the ratings of the selected user;
successively pairing the selected user with each mentor and computing a similarity function representing the overall rating agreement for the pair;
predicting the rating of the selected user for the not rated item from the similarity functions and the mentors' ratings of that item

2. The method of claim 1, further comprising the step of:
defining an objective archetype representing a class of hypothetical users.

3. The method of claim 1, wherein the predicting step comprises the step of:
applying a prediction function to the similarity functions, the mentor's ratings of the item not rated by the selected user, and a previously established prediction for the selected user's rating of that item.

4. The method of claim 1, further comprising the step of:
combining a plurality of users in the group into a composite archetype having ratings reflecting the ratings of the combined users;
wherein the selecting step selects the set of mentors from the plurality of objective archetypes, the group of users, and the composite archetype.

5. The method of claim 4, further comprising the step of:
removing each of the users combined into the composite archetype from the group of users from which mentors are selected.

6. The method of claim 4, wherein the combining step combines one or more objective archetypes into the composite archetype.

7. The method of claim 4, wherein the combining step further comprises the steps of:
recording the ratings reflecting the combined users as a mean and a variance of the individual ratings; and
storing a confidence value with the mean and variance indicating a confidence that the ratings are accurate.

8. The method of claim 1 wherein the similarity function computes an inverse of a weighted sum of normalized difference functions of ratings of items rated by the selected user mentor pair.

9. The method of claim 1, further comprising the step of:
storing the predicted rating of the selected user for use as a mentor in subsequent predictions.

10. The method of claim 1, wherein each rating is specified as a multidimensional value, with each dimension representing a different reaction type that led to the rating.

11. The method of claim 1, wherein computer program steps for performing the method are encoded on a computer-readable medium.

12. A system for predicting, for a user selected from a group of users, the reactions of the selected user to items sampled by one or more users in the group but not sampled by the selected user, comprising:
a module for defining, for each item sampled by the selected user, a rating representing the reaction of the selected user to that item;
a module for defining a set of raters from the group of users, each rater in the set having a rating for one or more items sampled by the selected user, wherein at least one rater is an objective archetype having hypothetical user ratings for one or more items sampled by the selected user;
a module for successively pairing the selected user with each rater to determine a difference in ratings for items sampled by both members of each successive pair;
a module for designating at least one of the raters as a mentor and assigning a similarity function to the mentor based on the difference in ratings between that mentor and the selected user; and
a module for predicting the reaction of the selected user to the items not yet sampled by the selected user from a prediction function based on the similarity function, the at least one mentor's rating of the items, and a previously determined prediction of the selected user's reaction to the items.

13. A method of automatically predicting, for a user selected from a group of users, the reactions of the selected user to items sampled by one or more users in the group but not sampled by the selected user, the reaction predictions being based on other items previously sampled by the selected user, comprising:
defining, for each item sampled by the selected user, a rating representing the reaction of the selected user to that item;
defining a set of raters including ones of the group of users, each rater in the set having a rating for one or more items sampled by the selected user, wherein at least one rater is an objective archetype having hypothetical user ratings for one or more items sampled by the selected user;
successively pairing the selected user with the raters to determine a difference in ratings for items sampled by both members of each successive pair;
designating at least one of the raters as a mentor and assigning a similarity function based on the difference in ratings between that mentor and the selected user; and
predicting the reaction of the user to the items not sampled by the selected user from a prediction function based on the similarity function, the mentor's rating of the items, and a previously determined prediction of the user's reaction to the items.

14. The method of claim 13, wherein the prediction function computes a weighted average of individual mentor ratings.

15. The method of claim 13, further comprising the step of:
computing a characteristic multidimensional value representing statistical properties of the ratings of each mentor and the selected user;
wherein the characteristic values are parameters to the prediction function.

16. The method of claim 13, wherein the similarity function computes an inverse of a weighted sum of normalized difference functions of ratings of items rated by that mentor and the selected user.

17. The method of claim 13, further comprising the step of:
forming a composite archetype having ratings reflecting ratings of a plurality of users in the group, wherein at least one rater is the composite archetype.

18. The method of claim 17, wherein the forming step comprises the steps of:
recording the ratings reflecting ratings of a plurality of users in the group as a mean and variance of the individual ratings; and
storing confidence values with the ratings reflecting the plurality of users in the group indicating a confidence that the ratings are accurate.

19. The method of claim 13, further comprising the step of:
storing the predicted reaction of the user to the items not sampled for use as a rater in subsequent predictions.

20. The method of claim 13, wherein each rating is a multidimensional value, with each dimension representing a different reaction type that led to the rating.

21. The method of claim 13, further comprising the step of:
if the predicted rating exceeds a predetermined threshold, notifying the selected user of the prediction.

22. The method of claim 21, wherein the notice is unsolicited.

23. The method of claim 13, wherein computer program steps for performing the method are encoded on a computer-readable medium.

24. The method of claim 13, wherein the method steps are performed on a computer system having a plurality of processors and wherein the defining, successively pairing, and designating steps are performed in parallel on ones of the plurality of processors.
